(19) United States
(12) Patent Application Publication
(10) Pub. No.: US 2023/0353462 A1
(43) Pub. Date: Nov. 2, 2023

(54) APPARATUS FOR VISUALIZING SECURITY TOPOLOGY OF CLOUD AND INTEGRATED SYSTEM FOR MANAGING OPERATION AND SECURITY OF CLOUD WORKLOAD USING THE SAME

(71) Applicant: ASTRONSECURITY, Seoul (KR)

(72) Inventor: Keunseok CHO, Anyang-si (KR)

(21) Appl. No.: 18/054,423

(22) Filed: Nov. 10, 2022

(30) Foreign Application Priority Data
Apr. 30, 2022 (KR) 10-2022-0053883
May 16, 2022 (JP) 2022-80216

(51) Int. Cl. H04L 41/22; H04L 41/122

(52) U.S. Cl. CPC H04L 41/22; H04L 41/122

(57) ABSTRACT

An apparatus for visualizing security topology of cloud may include a first information collecting unit collecting first information including at least network information, a cloud firewall policy, information on a cloud server, an availability zone, and an autoscaling group through API communication. The apparatus may also include a first screen configuring unit analyzing interaction and association with respect to an object, a network, and the first information and building a first screen in which a subnet, a security group, and a relationship among a plurality of cloud servers for a specific VPC are iconized. The apparatus may further include a second information collecting unit collecting second information including at least resource information, status information, integrity information, log information, system account information, and host firewall information. The apparatus may further include a second screen configuring unit building a second screen based on the second information.

### CROSS-REFERENCE TO RELATED APPLICATIONS

This application is based upon and claims the benefit of priority from Korean Patent Application No. 10-2022-0053883, filed Apr. 30, 2022 and Japanese Patent Application No. 2022-80216, filed May 16, 2022, the entire contents of which are incorporated herein by reference.

### BACKGROUND

### Technical Field

The present disclosure relates to an apparatus for visualizing security topology of cloud and integrated system for managing operation and security of cloud workload using the same.

### Description of Related Technology

A cloud service provider offers cloud services including application programming interface (API) management, cloud-based operating system and development template library, and the like by virtualizing infrastructure, platform, and application from its own hardware (for example, Alibaba Cloud, Microsoft Azure, Google Cloud, Amazon Web Services (AWS), Oracle Cloud Infrastructure, IBM Cloud, Naver, Kakao, KT, NHN, etc.).

The cloud computing provides computing services including server, storage, database, networking, software, analysis, intelligence, and the like through the Internet (cloud), from which a user can secure resources for target information technology taking advantage of flexible resources.

From a business point of view, the cloud computing brings merits of adjusting the size depending on the business requirement as well as the cost reduction and efficient running of the infrastructure.

On the other hand, when operation and security problems occur due to sudden creation, deletion, and alteration of cloud servers, such cloud computing, which substitutes the legacy physical environment with the logical environment, has a drawback of various types of security vulnerability as well as difficulty in checking and responding to the problems in real time.

The cloud server means a centralized server provide through a network (for example, the Internet) to which a plurality of users can access on demand through virtualization, including a host in a broad scope and a virtual server, a docker, a container, and the like in a narrow scope.

To cope with the above problems, Korean Patent No. 10-2164915 proposes a system for creating a security topology for understanding a relationship between objects by classifying information on configuration of the virtual private cloud (VPC) and information on security policies through collection and analysis of API of the VPC from the API communication with the cloud service provider system

### SUMMARY

According to some embodiments of the present disclosure, an apparatus for visualizing security topology of cloud includes a processor including a first information collecting unit configured to collect, from a cloud service provider, first information including at least network information of a cloud, firewall policy of the cloud, information on a cloud server, availability zone, and autoscaling group through application programming interface (API) communication, a first screen configuring unit configured to perform an analysis of interaction and association with respect to object, network, cloud firewall policy, cloud server, availability zone, and autoscaling group used in the cloud based on the first information collected by the first information collecting unit and to build a first screen in which subnet, security group, and relationship among a plurality of cloud servers for a specific virtual private cloud (VPC) are iconized, based on a result of the analysis, a second information collecting unit configured to collect, from the cloud service provider, second information including at least resource information, status information, integrity information, log information, system account information, and host firewall information of a cloud server through agent communication, a second screen configuring unit configured to build a second screen in which cloud server status, agent status, host firewall status, monitoring alarm, and integrity check result are reflected, based on the second information collected by the second information collecting unit, and an output unit configured to output the first screen built by the first screen configuring unit and the second screen built by the second screen configuring unit to a user terminal.

According to some embodiments of the present disclosure, a system for managing operation and security of cloud workload includes the apparatus according to some embodiments of the present disclosure and a cloud status displaying unit configured to display a status screen indicating at least one or more statuses of user account, host, integrity, application, resource, service change, and firewall based on the first information collected by the first information collecting unit and the second information collected by the second information collecting unit using at least one or more of icon, text, number, and symbol separately from the first screen and the second screen on the user terminal.

According to some embodiments of the present disclosure, an apparatus for visualizing security topology of cloud includes a processor including a first information collecting unit configured to collect, from a cloud service provider, first information including at least account information, resource information, firewall information, and network information of a cloud through application programming interface (API) communication, a first screen configuring unit configured to perform an analysis of interaction and association with respect to object, network, cloud firewall policy, cloud server, and availability zone used in the cloud based on the first information collected by the first information collecting unit and to build a first screen in which subnet, security group, and relationship among a plurality of cloud servers for a specific virtual private cloud (VPC) are iconized, based on a result of the analysis, a second screen configuring unit configured to build a second screen in which information on the network, the firewall policy, the cloud server, and the availability zone are reflected, and an output unit configured to output the first screen built by the first screen configuring unit and the second screen built by the second screen configuring unit to a user terminal. When a plurality of VPCs exists in the cloud, the first screen configuring unit and the second screen configuring unit are configured to build the first screen and the second screen, respectively, for each of the plurality of VPCs, and the output unit is configured to output the first screen and the second screen for each of the plurality of VPCs to the user terminal via a plurality of windows.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an apparatus for visualizing security topology of cloud according to some embodiments of the present disclosure;

FIG. 2 is a schematic diagram for explaining icons used in the apparatus for visualizing security topology of cloud according to some embodiments of the present disclosure;

FIG. 3 is a schematic diagram of a security topology screen for a plurality of VPCs in the apparatus for visualizing security topology of cloud according to some embodiments of the present disclosure;

FIG. 4 is a flowchart for explaining an operation of the apparatus for visualizing security topology of cloud according to some embodiments of the present disclosure;

FIG. 5 is a schematic diagram of an apparatus for visualizing security topology of cloud according to some embodiments of the present disclosure;

FIG. 6 is a schematic diagram of an integrated system for managing operation and security of cloud workload according to some embodiments of the present disclosure;

FIG. 7 is a flowchart for explaining an operation of the integrated system for managing operation and security of cloud workload according to some embodiments of the present disclosure; and

FIG. 8 is a schematic diagram of a security topology and monitor screen in the integrated system for managing operation and security of cloud workload according to some embodiments of the present disclosure.

### DETAILED DESCRIPTION

Exemplary embodiments of the present disclosure are described in detail below with reference to the accompanying drawings.

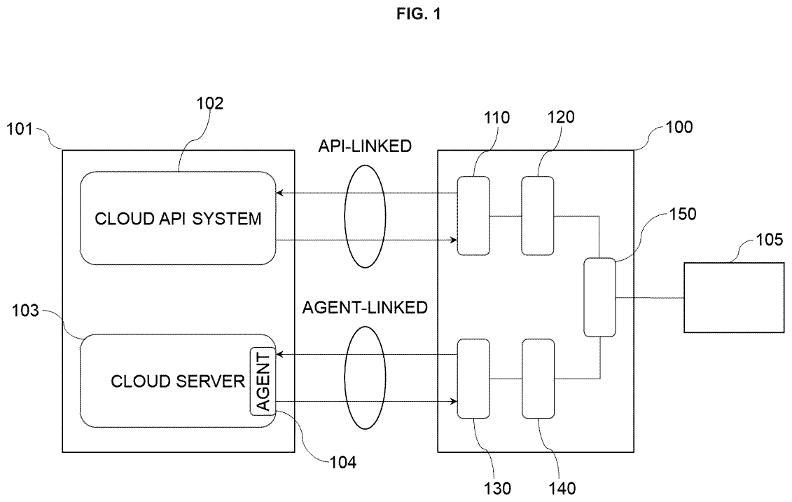

FIG. 1 is a schematic diagram of an apparatus 100 for visualizing security topology of cloud according to some embodiments of the present disclosure.

The apparatus 100 according to some embodiments of the present disclosure visualizes the overall scheme regarding operation and security of the cloud including configuration information, configuration diagram, connection status, setting values, and the like of cloud servers, virtual network devices, cloud firewall, and the like, and allows an administrator to be rapidly aware of a risk factor by reflecting updated information in real time.

The visibility problem in a typical cloud is caused by lack of configuration diagram of the network, lack of connection diagram of cloud servers, difficulty in understanding allow/block information by the firewall policy, and the like. When there is a lack of visibility, virtually every operation needs to be checked manually one by one, causing difficulty and time in understanding the situation.

Therefore, the apparatus 100 according to some embodiments of the present disclosure is capable of greatly reducing operation time and security responding time as well as enhancing convenience in operation, by providing a topology (arrangement) with clear indication of the status.

As shown in FIG. 1, the apparatus 100 according to some embodiments of the present disclosure includes a first information collecting unit 110 for collecting, from a cloud service provider 101, first information including at least network information of a cloud, firewall policy of the cloud, information on a cloud server, availability zone, and autoscaling group through application programming interface (API) communication (link), a first screen configuring unit 120 for analyzing interaction and association with respect to object, network, cloud firewall policy, cloud server, availability zone, and autoscaling group used in the cloud based on the first information collected by the first information collecting unit 110 and building a first screen in which subnet, security group, and relationship among a plurality of cloud servers for a specific virtual private cloud (VPC) are iconized, based on a result of analysis, a second information collecting unit 130 for collecting, from the cloud service provider 101, second information including at least resource information, status information, integrity information, log information, system account information, and host firewall information of a cloud server through agent communication (link), a second screen configuring unit 140 for building a second screen in which cloud server status, agent status, host firewall status, monitoring alarm, and integrity check result are reflected, based on the second information collected by the second information collecting unit 130, and an output unit 150 for combining the first screen built by the first screen configuring unit 120 and the second screen built by the second screen configuring unit 140 and outputting a combined screen to a user terminal 105.

Each of the first information collecting unit 110, the first screen configuring unit 120, the second information collecting unit 130, the second screen configuring unit 140, and the output unit 150 is implemented in a processor (e.g., a CPU) as a program module to perform the corresponding function.

The cloud server is a resource existing on an operating system (OS) that is virtually created in a physical server. In order to analyze a cloud server, the API provided by the cloud service provider needs to be analyzed first and data received through the API is stored in a recording medium.

The information received through the API includes account information for each user or administrator, login information, cloud resource information, virtual server information, network configuration information, firewall information, firewall policy information (allow and block), virtual server status information, autoscaling information, and the like.

all status values are stored in a database by way of installing an agent in an individual cloud server. The values obtained through the agent may include information on the hardware of the cloud server, information on the software installed, resource information of the operating cloud server, information on a process installed in the cloud server, information on file change in the cloud server, information on a user account logged in the cloud server, information on the firewall applied to the cloud server, and the like.

In some embodiments of the present disclosure, the first information collected by the first information collecting unit 110 of the apparatus 100 includes account information (cloud account information), resource information (cloud server information and network information), firewall information (type and policy of cloud firewall), network information (region, availability zone, VPC, and subnet), and autoscaling information (information on automatically created cloud server), and the like which can be obtained through the API communication from the cloud service provider 101.

That is, the apparatus 100 according to some embodiments of the present disclosure creates a basic topology by receiving the first information through a communication with an API system 102 of the cloud service provider 101, allowing a user to divide the logical network, to check a cloud server included in the network, to check the connection status between cloud servers by analyzing the firewall policy, to tell apart cloud servers influenced by the same firewall policy and to check the cloud firewall policy, and to check firewall policy collision and policy overlap for each cloud virtual server and to perform a connection status simulation for each policy.

In some embodiments of the present disclosure, the second information collected by the second information collecting unit 130 of the apparatus 100 includes resource information (resource information and resource status information of the cloud server), status information (cloud server process-related information, up-down information, traffic information, and information on installed application), integrity information (file tempering information and configuration file change information), log information (various log data, system log, and event log), system account information (account information and login information of the cloud server), host firewall information (host firewall policy), and the like which can be obtained through the agent communication (link) from the cloud service provider 101.

That is, the apparatus 100 according to some embodiments of the present disclosure receives the second information via a communication with an agent 104 installed in a cloud server 103 of the cloud service provider 101 and allows a user to check various security and operation statuses on the basic topology, to check connection status among cloud servers through an analysis of the host firewall policy, and to check cloud server up-down status, resource status, integrity status, log information, system account information, host firewall block log, and application information for each resource.

In this specification, it is assumed that an agent is installed in advance in each of the necessary servers, and detailed description on download, install, and configuration of an agent package is omitted.

Upon analyzing the cloud system for creating a security topology, collection of the overall information on a cloud system through the API allows a user to check configuration information, connection information, and firewall policy information of the cloud system, enables implementation of configuration suited to characteristics of the cloud, such as the autoscaling, and enables application of the firewall allow/block policy. On the other hand, this scheme has a drawback of difficulty in figuring out information on various statuses in the cloud server.

On the contrary, collecting additional information through a separate agent allows the user to figure out the status information in the cloud server, but it is difficult to figure out the configuration information, the connection information, and the like of the cloud system.

The apparatus 100 according to some embodiments of the present disclosure allows the user to figure out the precise configuration information and the connection information of the cloud and the internal status information of the cloud server, by combining the scheme of collecting the overall information on the cloud system through the API and the scheme of collecting additional information through the separate agent.

With this scheme, the apparatus 100 according to some embodiments of the present disclosure enables the total status check for security and operation of the cloud.

In some embodiments of the present disclosure, the first screen configuring unit 120 determines contents and icons to be displayed on the first screen based on numbers and connection analysis of subnets, security groups, and cloud servers configuring the VPC.

In some embodiments of the present disclosure, the first screen configuring unit 120 determines icons to indicate the subnet, the security group, and the relationship among the plurality of cloud servers configuring the VPC in a different manner for each cloud.

In some embodiments of the present disclosure, when there is a change in at least one or more of the network information, the cloud firewall policy, the information on the cloud server, the availability zone, and the autoscaling group included in the first information collected by the first information collecting unit 110, the first screen configuring unit 120 dynamically reflects content of the change on the first screen.

In some embodiments of the present disclosure, when there is a change in at least one or more of the cloud server status, the agent status, the host firewall status, the monitoring alarm, and the integrity check result based on the second information collected by the second information collecting unit 130, the second screen configuring unit 140 dynamically reflects content of the change on the second screen.

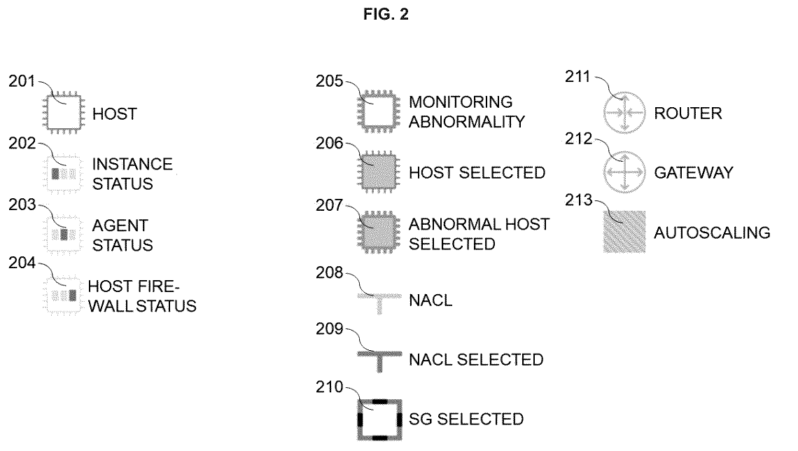

FIG. 2 is a schematic diagram for explaining icons used in the apparatus 100 for visualizing security topology of cloud according to some embodiments of the present disclosure.

As shown in FIG. 2, in some embodiments of the present disclosure, the icons used in the apparatus 100 include, for example, a host icon 201, an instance status icon 202, an agent status icon 203, a host firewall status icon 204, an abnormality alarm icon 205, a host selected icon 206, an abnormal host selected icon 207, a network access control list (NACL) icon 208, an NACL selected icon 209, a security group (SG) selected icon 210, a router icon 211, a gateway icon 212, and an autoscaling icon 213.

In some embodiments of the present disclosure, status icons including the instance status icon 202, the agent status icon 203, the host firewall status icon 204 can represent statuses of running, not running, normal, error, not installed, not used, and the like using different colors.

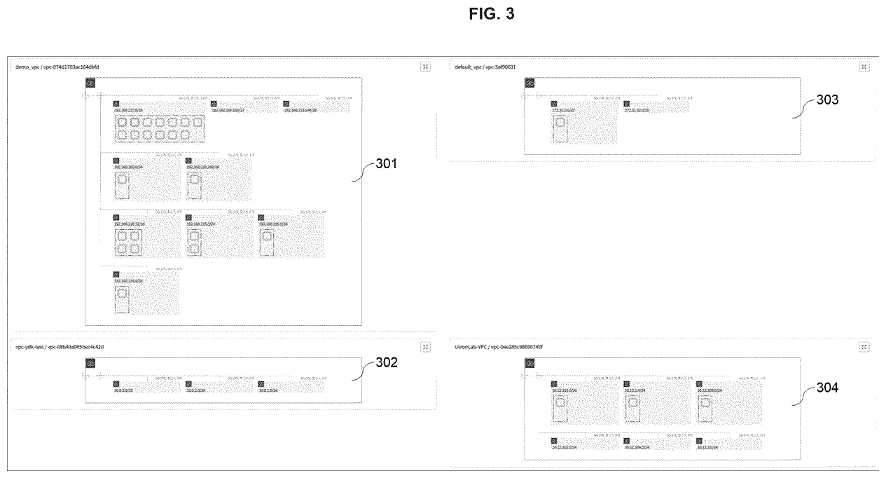

FIG. 3 is a schematic diagram of a security topology screen for a plurality of VPCs in the apparatus for visualizing security topology of cloud according to some embodiments of the present disclosure.

In some embodiments of the present disclosure, when a plurality of VPCs exists in the cloud, the first screen configuring unit 120 and the second screen configuring unit 140 build the first screen and the second screen, respectively, for each of the plurality of VPCs, and the output unit 150 outputs the first screen and the second screen for each of the plurality of VPCs to the user terminal 105 via a plurality of windows.

FIG. 3 shows an example of simultaneously displaying a first topology 301 for a first VPC, a second topology 302 for a second VPC, a third topology 303 for a third VPC, and a fourth topology 304 for a fourth VPC divided into four windows.

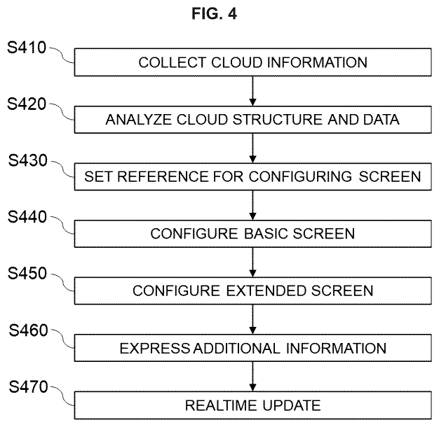

FIG. 4 is a flowchart for explaining an operation of the apparatus 100. visualizing security topology of cloud according to some embodiments of the present disclosure.

As shown in FIG. 4, the apparatus 100 creates the first screen and the second screen through a cloud information collecting step (Step S410), a cloud structure and data analyzing step (Step S420), a screen configuration reference setting step (Step S430), a basic screen building step (Step S440), an extended screen building step (Step S450), an additional information representing step (Step S460), and a realtime update step (Step S470).

In Step S410, the apparatus 100 collects host information of a cloud system (for example, AWS, AZure, GCP, and the like), collects detailed information on network (gateway, router, VPC, and subnet), cloud firewall (network ACL and security group) policy, cloud server, availability zone (AZ), autoscaling, and the like through the API provided by the cloud, and collects information on usage of server and resource, integrity check, host firewall, and the like through an agent installed in the cloud server.

In Step S420, the apparatus 100 analyzes interaction and association with respect to object, network (gateway, router, VPC, and subnet), cloud firewall (network ACL, security group) policy, cloud server, AZ, autoscaling, and the like used in the cloud, performs data configuration for representation on information collected at a host through an analysis job as well, checks network connection of each cloud server without traffic information through analysis of the firewall policy, and displays autoscaling group information to precisely represent the corresponding group even with a scale up/down in real time.

In Step S430, the apparatus 100 determines contents of the basic screen through analysis of a small network group (subnet), a security group (SG), the number of cloud servers and connection of the cloud servers, configures the basic screen to display more detailed contents when there is not much information or to display basic information and grouping as well as configures the extended screen in a plurality of stages when there is much information to be displayed.

In Step S440, the apparatus 100 represents subnet information and cloud server and security group information to figure out the relationship between them.

In Step S450, the apparatus 100 represents information on the cloud server status, the agent status, the host firewall status, the monitoring alarm, the integrity check result, and the like, to allow the user to figure out detailed information on the network (gateway, router, VPC, and subnet), the firewall policy, the cloud server, the AZ, the autoscaling group, and the like.

In Step S460, the apparatus 100 represents the configuration and connection of cloud firewall (network ACL and security group) on the topology when selecting each unit, provides In/Out policy display and edit functions upon clicking the cloud firewall and host firewall (applying realtime policy), enables clear policy making through the policy edit functions, minimizes user errors, displays connection line and detailed communication information for network communication-allowed interval in the cloud server with the connection line implemented to represent the communication direction and the number of policies, displays grouped representation of a plurality of cloud servers, provides multiple screens to compare a plurality of VPC topologies, and provides check and representation of collision status and overlap status among firewall policies applied to the cloud server and simulation function with respect to the firewall policy applied to the cloud server.

In Step S470, when there is a change in at least one or more of network information, cloud firewall policy, cloud server, availability zone, and autoscaling group, the apparatus 100 repeats necessary steps of Step S410 to Step S460 to dynamically reflect contents of the change and configure the basic screen, and when there is a change in one or more of cloud server status, agent status, host firewall status, monitoring alarm, and integrity check result, dynamically reflects contents of the change to configure the extended screen and to represent additional information.

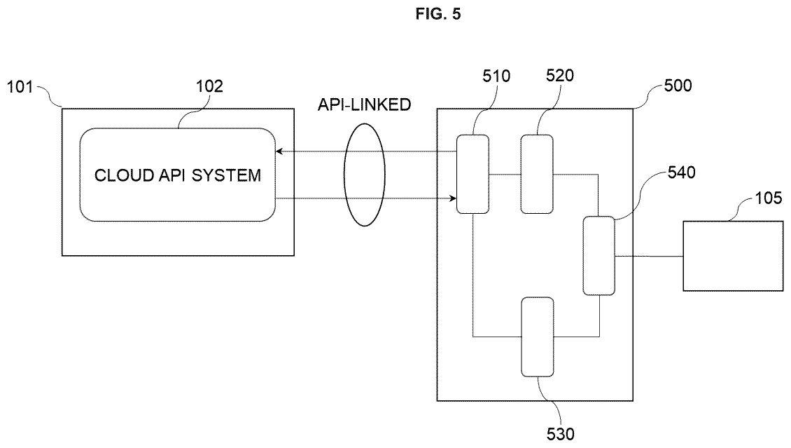

FIG. 5 is a schematic diagram of an apparatus 500 for visualizing security topology of cloud according to some embodiments of the present disclosure.

As shown in FIG. 5, the apparatus 500 according to some embodiments of the present disclosure includes a first information collecting unit 510 configured to collect, from a cloud service provider 101, first information including at least account information, resource information, firewall information, and network information of a cloud through application programming interface (API) communication, a first screen configuring unit 520 configured to perform an analysis of interaction and association with respect to object, network, cloud firewall policy, cloud server, and availability zone used in the cloud based on the first information collected by the first information collecting unit 510 and to build a first screen in which subnet, security group, and relationship among a plurality of cloud servers for a specific virtual private cloud (VPC) are iconized, based on a result of the analysis, a second screen configuring unit 530 configured to build a second screen in which information on the network, the firewall policy, the cloud server, and the availability zone are reflected, and an output unit 540 configured to output the first screen built by the first screen configuring unit 520 and the second screen built by the second screen configuring unit 530 to a user terminal 105.

In some embodiments of the present disclosure, when a plurality of VPCs exists in the cloud, the first screen configuring unit 520 and the second screen configuring unit 530 build the first screen and the second screen, respectively, for each of the plurality of VPCs, and the output unit 540 outputs the first screen and the second screen for each of the plurality of VPCs to the user terminal 105 via a plurality of windows.

In some embodiments of the present disclosure, the first information collected by the first information collecting unit 510 of the apparatus 500 includes account information (cloud account information), resource information (cloud server information and network information), firewall information (type and policy of cloud firewall), and network information (region), which can be obtained through the API communication from the cloud service provider 101.

In some embodiments of the present disclosure, the first information collected by the first information collecting unit 510 of the apparatus 500 further includes autoscaling information.

That is, the apparatus 500 according to some embodiments of the present disclosure creates a basic topology by receiving the first information through a communication with an API system 102 of the cloud service provider 101, allowing a user to divide the logical network, to check a cloud server included in the network, to check the connection status between cloud servers by analyzing the firewall policy, to tell apart cloud servers influenced by the same firewall policy and to check the cloud firewall policy, and to check firewall policy collision and policy overlap for each cloud virtual server and to perform a connection status simulation for each policy.

Such basic security topology can provide visibility for minimum operation and security of the cloud workload.

In some embodiments of the present disclosure, the first screen configuring unit 520 determines contents and icons to be displayed on the first screen based on numbers and connection analysis of subnets, security groups, and cloud servers configuring the VPC.

In some embodiments of the present disclosure, the first screen configuring unit 520 determines icons to indicate the subnet, the security group, and the relationship among the plurality of cloud servers configuring the VPC in a different manner for each cloud.

In some embodiments of the present disclosure, when there is a change in at least one or more of the network information, the firewall policy, the information on the cloud server, and the availability zone included in the first information collected by the first information collecting unit 510, the first screen configuring unit 520 dynamically reflects content of the change on the first screen.

In some embodiments of the present disclosure, when there is a change in at least one or more of the network information, the firewall policy, the information on the cloud server, and the availability zone included in the first information collected by the first information collecting unit 510, the second screen configuring unit 530 dynamically reflects content of the change on the second screen.

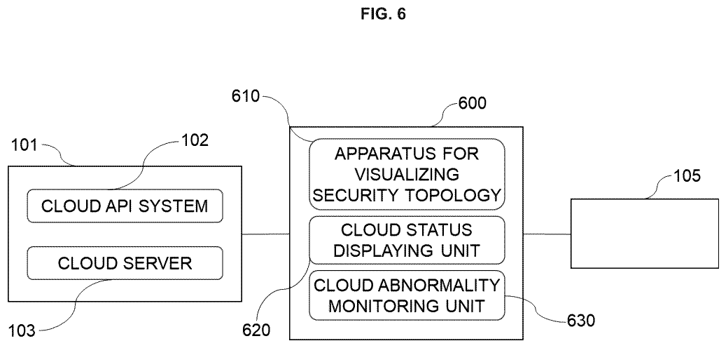

FIG. 6 is a schematic diagram of a system 600 for managing operation and security of cloud workload according to some embodiments of the present disclosure.

In some embodiments of the present disclosure, the cloud workload refers to specific application, service, function, or work amount capable of being executed at the cloud resource, which includes cloud server, database, container, application, and the like.

As shown in FIG. 6, the system 600 according to some embodiments of the present disclosure includes an apparatus 610 for visualizing security topology, a cloud status displaying unit 620 configured to display a status screen indicating at least one or more statuses of user account, host, integrity, application, resource, service change, and firewall, and a cloud abnormality monitoring unit 630 configured to monitor at least one or more of the user account, the host, the integrity, the application, the resource, the service change, and the firewall.

The apparatus 610 has a structure similar to that of the apparatus 100 shown in FIG. 1, and for detailed description thereof, please refer to FIGS. 1 to 4 with corresponding descriptions.

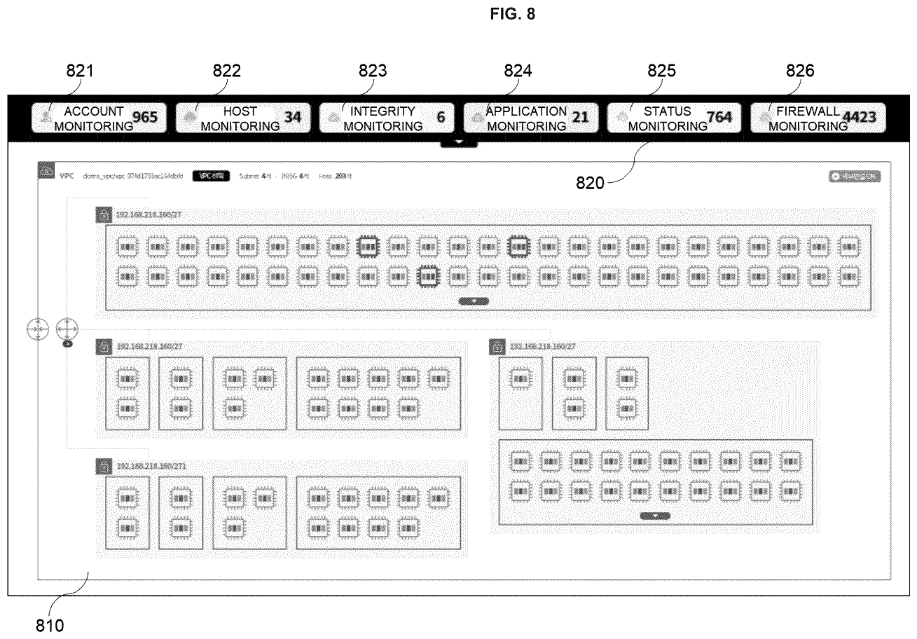

In some embodiments of the present disclosure, the cloud status displaying unit 620 displays a status screen indicating at least one or more statuses of user account, host, integrity, application, resource, service change, and firewall based on the first information collected by the first information collecting unit 110 and the second information collected by the second information collecting unit 130 using at least one or more of icon, text, number, and symbol separately from the first screen and the second screen on the user terminal 105 (see FIG. 8).

In some embodiments of the present disclosure, the cloud abnormality monitoring unit 630 monitors at least one or more of the user account, the host, the integrity, the application, the resource, the service change, and the firewall based on the first information collected by the first information collecting unit 110 and the second information collected by the second information collecting unit 130.

Upon detecting an abnormality in at least one or more of the user account, the host, the integrity, the application, the resource, the service change, and the firewall, the cloud abnormality monitoring unit 630 displays an abnormality status using at least one or more of the icon, the text, the number, and the symbol on the status screen separately from the first screen and the second screen.

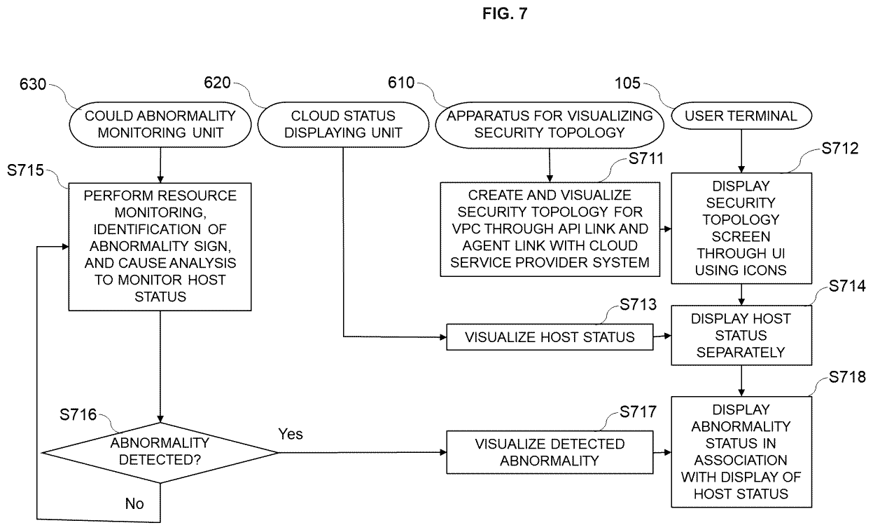

FIG. 7 is a flowchart for explaining an operation of the system 600 according to some embodiments of the present disclosure.

In Step S711, the apparatus 610 creates a security topology for a specific VPC through the API communication and the agent communication with a cloud service provider.

In Step S712, the user terminal 105 displays the security topology received from the apparatus 610 on a display (not shown) thereof.

In Step S713, the cloud status displaying unit 620 visualizes the host status including at least one or more of user account, host, integrity, application, resource, service change, and firewall.

In Step S714, the cloud status displaying unit 620 displays a status screen indicating the host status independently from the security topology screen.

In Step S715, the cloud abnormality monitoring unit 630 performs monitoring of resource, identification of abnormality sign, and analyzing cause.

In Step S716, upon detecting an abnormality (Yes), the cloud abnormality monitoring unit 630 visualizes detected abnormality in Step S717, and upon detecting no abnormality (No), returns to Step S715 to continue monitoring.

In Step S718, the cloud abnormality monitoring unit 630 displays contents of abnormality detection in association with the display of host status.

FIG. 8 is a schematic diagram of a security topology and monitor screen in the system 600 according to some embodiments of the present disclosure.

As shown in FIG. 8, the security topology and monitor screen according to some embodiments of the present disclosure includes a security topology window 810 and a status window 820.

The security topology window 810 displays a security topology screen for a specific VPC created by the apparatus for visualizing security topology of cloud according to some embodiments of the present disclosure, and the status window 820 displays a status screen for at least one or more of user account, host, integrity, application, resource, service change, and firewall created by the cloud status displaying unit 620 according to some embodiments of the present disclosure.

In the example shown in FIG. 8, the status window 820 includes account 821, host 822, integrity 823, application 824, status 825, and firewall 826. The number on the right side of each item represents the number of events.

Although it is not shown in FIG. 8, in some embodiments of the present disclosure, when an abnormality is detected by the cloud abnormality monitoring unit 630 in any one or more of the account 821, the host 822, the integrity 823, the application 824, the status 825, and the firewall 826 of the status window 820, the cloud status displaying unit 620 displays the abnormality status on the corresponding item using at least one or more of icon, text, number, and symbol.

The apparatus for visualizing security topology of cloud according to some embodiments of the present disclosure and the system for managing operation and security of cloud workload according to some embodiments of the present disclosure offer a cloud workload security solution with precise cloud security using a hybrid scheme combining the API scheme and the agent scheme, providing the optimized security for the cloud native environment by implementing the visibility-based security management.

In addition, the apparatus for visualizing security topology of cloud according to some embodiments of the present disclosure and the system for managing operation and security of cloud workload according to some embodiments of the present disclosure can provide multi-cloud integrated environment through support for both global cloud and domestic cloud and support for both private cloud and on-premise server.

That is, the apparatus for visualizing security topology of cloud according to some embodiments of the present disclosure and the system for managing operation and security of cloud workload according to some embodiments of the present disclosure can support both cloud native security based on API scheme and system security based on agent scheme and provide distinguished functions in visibility and detection of abnormal behavior.

Accordingly, it is possible to perform both security and system account monitoring through the API and abnormal behavior monitoring (cloud, account, application, tempering, status, log, and the like) through the agent.

Therefore, with the apparatus for visualizing security topology of cloud according to some embodiments of the present disclosure and the system for managing operation and security of cloud workload according to some embodiments of the present disclosure, it is possible to support global and domestic multi-cloud system, to integrally manage the security in a hybrid environment in which on-premise server is combined, and to determine the abnormality sign by collecting and analyzing security data through both API and agent.

As described above, some embodiments of the present disclosure can provide an apparatus for visualizing security topology of cloud which allows an administrator to be rapidly aware of a risk factor by visualizing the overall environment regarding operation and security of a cloud, such as configuration information, configuration diagram, connection status, and setting value of cloud server, virtual network device, cloud firewall, and the like and reflecting updated information in real time.

Further, some embodiments of the present disclosure can provide a visibility-based integrated system for managing operation and security of cloud workload which allows an administrator to be rapidly aware of a risk factor by visualizing the overall environment regarding operation and security of a cloud, such as configuration information, configuration diagram, connection status, and setting value of cloud server, virtual network device, cloud firewall, and the like and reflecting updated information in real time.

The present disclosure should not be limited to these embodiments but various changes and modifications are made by one ordinarily skilled in the art within the subject matter, the spirit and scope of the present disclosure as hereinafter claimed. Specific terms used in this disclosure and drawings are used for illustrative purposes and not to be considered as limitations of the present disclosure. Exemplary embodiments of the present disclosure have been described for the sake of brevity and clarity. Accordingly, one of ordinary skill would understand the scope of the claimed invention is not to be limited by the explicitly described above embodiments but by the claims and equivalents thereof.

What is claimed is:

1. An apparatus for visualizing security topology of cloud, the apparatus comprising:
a processor including:
a first information collecting unit configured to collect, from a cloud service provider, first information including at least network information of a cloud, a firewall policy, information on a cloud server, an availability zone, and an autoscaling group through application programming interface (API) communication;
a first screen configuring unit configured to perform an analysis of interaction and association with respect to an object, a network, the cloud firewall policy, the cloud server, the availability zone, and the autoscaling group used in the cloud based on the first information collected by the first information collecting unit and to build a first screen in which a subnet, a security group, and a relationship among a plurality of cloud servers for a specific virtual private cloud (VPC) are iconized, based on a result of the analysis;
a second information collecting unit configured to collect, from the cloud service provider, second information including at least resource information, status information, integrity information, log information, system account information, and host firewall information of the cloud server through agent communication;
a second screen configuring unit configured to build a second screen in which a cloud server status, an agent status, a host firewall status, a monitoring alarm, and an integrity check result are reflected, based on the second information collected by the second information collecting unit; and
an output unit configured to output the first screen built by the first screen configuring unit and the second screen built by the second screen configuring unit to a user terminal.

2. The apparatus according to claim 1, wherein when a plurality of VPCs exist in the cloud,
the first screen configuring unit and the second screen configuring unit are configured to build the first screen and the second screen, respectively, for each of the plurality of VPCs, and
the output unit is configured to output the first screen and the second screen for each of the plurality of VPCs to the user terminal via a plurality of windows.

3. The apparatus according to claim 1, wherein the first screen configuring unit is configured to determine contents and icons to be displayed on the first screen based on numbers and connection analysis of subnets, security groups, and cloud servers configuring the VPC.

4. The apparatus according to claim 1, wherein the first screen configuring unit is configured to determine icons to indicate the subnet, the security group, and the relationship among the plurality of cloud servers configuring the VPC in a different manner for each cloud.

5. The apparatus according to claim 1, wherein when there is a change in at least one or more of the network information, the firewall policy, the information on the cloud server, the availability zone, and the autoscaling group included in the first information collected by the first information collecting unit, the first screen configuring unit is configured to dynamically reflect content of the change on the first screen.

6. The apparatus according to claim 1, wherein when there is a change in at least one or more of the cloud server status, the agent status, the host firewall status, the monitoring alarm, or the integrity check result based on the second information collected by the second information collecting unit, the second screen configuring unit is configured to dynamically reflect content of the change on the second screen.

7. A system for managing operation and security of cloud workload, the system comprising the apparatus according to claim 1, wherein:
the processor further includes a cloud status displaying unit configured to display a status screen indicating at least one or more statuses of a user account, a host, an integrity, an application, a resource, a service change, and a firewall based on the first information collected by the first information collecting unit and the second information collected by the second information collecting unit using at least one or more of an icon, a text, a number, or a symbol separately from the first screen and the second screen on the user terminal.

8. The system according to claim 7, wherein:
the processor further includes a cloud abnormality monitoring unit configured to monitor at least one or more of the user account, the host, the integrity, the application, the resource, the service change, or the firewall based on the first information collected by the first information collecting unit and the second information collected by the second information collecting unit, and
upon detecting an abnormality in at least one or more of the user account, the host, the integrity, the application, the resource, the service change, or the firewall, the cloud abnormality monitoring unit is configured to display an abnormality status using at least one or more of the icon, the text, the number, or the symbol on the status screen.

9. An apparatus for visualizing security topology of cloud, the apparatus comprising:
a processor including:
a first information collecting unit configured to collect, from a cloud service provider, first information including at least account information, resource information, firewall information, and network information of a cloud through application programming interface (API) communication;
a first screen configuring unit configured to perform an analysis of interaction and association with respect to an object, a network, a cloud firewall policy, a cloud server, and an availability zone used in the cloud based on the first information collected by the first information collecting unit and to build a first screen in which a subnet, a security group, and a relationship among a plurality of cloud servers for a specific virtual private cloud (VPC) are iconized, based on a result of the analysis;
a second screen configuring unit configured to build a second screen in which information on the network, the firewall policy, the cloud server, and the availability zone are reflected; and
an output unit configured to output the first screen built by the first screen configuring unit and the second screen built by the second screen configuring unit to a user terminal,
wherein when a plurality of VPCs exist in the cloud:
the first screen configuring unit and the second screen configuring unit are configured to build the first screen and the second screen, respectively, for each of the plurality of VPCs, and
the output unit is configured to output the first screen and the second screen for each of the plurality of VPCs to the user terminal via a plurality of windows.

10. The apparatus according to claim 9, wherein the first screen configuring unit is configured to determine contents and icons to be displayed on the first screen based on numbers and connection analysis of subnets, security groups, and cloud servers configuring the VPC.

11. The apparatus according to claim 9, wherein the first screen configuring unit is configured to determine icons to indicate the subnet, the security group, and the relationship among the plurality of cloud servers configuring the VPC in a different manner for each cloud.

12. The apparatus according to claim 9, wherein when there is a change in at least one or more of the network information, the firewall policy, the information on the cloud server, or the availability zone included in the first information collected by the first information collecting unit, the first screen configuring unit is configured to dynamically reflect content of the change on the first screen.

13. The apparatus according to claim 9, wherein when there is a change in at least one or more of the network information, the firewall policy, the information on the cloud server, or the availability zone included in the first information collected by the first information collecting unit, the second screen configuring unit is configured to dynamically reflect content of the change on the second screen.
